(19) United States
(12) Patent Application Publication
(10) Pub. No.: US 2023/0384140 A1
(43) Pub. Date: Nov. 30, 2023

(54) FLUID FLOW SENSOR WITH LOW FREQUENCY SAMPLING FOR FLOW DETECTION

(71) Applicant: FlowActive, Inc., Troy, NY (US)

(72) Inventors: Frank Lipowitz, Rexford, NY (US); Karl Appel, Albany, NY (US); Robert C. Tatar, Saratoga Springs, NY (US); Michael Wilkinson, Delmar, NY (US); Matthew Cusack, Troy, NY (US)

(21) Appl. No.: 18/322,712

(22) Filed: May 24, 2023

Related U.S. Application Data
(60) Provisional application No. 63/365,224, filed on May 24, 2022.

(51) Int. Cl. G01F 15/06; G01F 1/075; G01F 1/115

(52) U.S. Cl. CPC G01F 15/068; G01F 1/0755; G01F 1/1155

(57) ABSTRACT

A system and method for detecting and analyzing fluid flow. The system includes a turbine that rotates in response to a fluid flow; a sensor that senses positional information of the turbine; a flow detector coupled to the sensor that: periodically captures and stores a value indicative of a position of the turbine; compares the value with a previously collected value; and detects flow if the value and previously collected value differ; and a flow analysis system coupled to the sensor that activates in response to a detected flow, wherein the flow analysis system collects and analyzes sensor data from the sensor.

### PRIORITY

This application claims priority provisional application Flow Detection with Low Frequency Magnetic Field Sampling, Ser. No. 63/365,224, filed on May 24, 2022, the contents of which are hereby incorporated by reference.

### TECHNICAL FIELD

The subject matter of this disclosure relates to fluid flow sensing and measurement systems, and more particularly to a sensor system that uses low frequency sampling to detect fluid flow.

### BACKGROUND

As water resources become scarcer and more expensive, water management in large facilities such as apartments, commercial buildings, hotels, etc., will continue to become more and more important. Among the challenges facility owners and managers face is to ensure that water waste is minimized. Providing sensors that can detect water flow in plumbing fixtures (pipe, tubes, etc.) and like accordingly remains an essential endeavor.

One area where water waste is commonplace involves leaking bathroom appliances such as toilets. A simple slow leak may go undetected for some time as the toilet will continue to operate but will repeatedly discharge water as though it was partially flushed. More involved leaks could result in an overflow situation causing significant flood damage to the facility.

### SUMMARY

Aspects of the disclosure provide a system and method that uses a fluid flow measurement sensor as a fluid flow detector using low frequency sampling. Upon detection, the system transitions from a detection mode to a measurement mode. The measurement mode utilizes a flow analysis system that can collect data, automatically detect leaks, provide alerts, measure water flow, provide analytics for water use in a toilet, turn off water supply, etc.

In a first aspect, system for detecting and analyzing fluid flow is provided, comprising: a turbine that rotates in response to a fluid flow; a sensor that senses positional information of the turbine; a flow detector coupled to the sensor that: periodically captures and stores a value indicative of a position of the turbine; compares the value with a previously collected value; and detects flow if the value and previously collected value differ; and a flow analysis system coupled to the sensor that activates in response to a detected flow, wherein the flow analysis system collects and analyzes sensor data from the sensor.

In a second aspect, method for detecting and analyzing fluid flow is provided, comprising: providing a turbine that rotates in response to a fluid flow; providing a sensor that senses positional information of the turbine; periodically capturing and storing a value indicative of a position of the turbine; comparing the value with a previously collected value; detecting a fluid flow if the value and previously collected value differ; and activating a flow analysis system in response to a detected flow, wherein the flow analysis system collects and analyzes sensor data from the sensor.

In a third, aspect, a plumbing fixture is provided, comprising: a system for detecting and analyzing fluid flow, including: a turbine that rotates in response to a fluid flow; a sensor that senses positional information of the turbine; a flow detector coupled to the sensor that: periodically captures and stores a value indicative of a position of the turbine; compares the value with a previously collected value; and detects flow if the value and previously collected value differ; and a flow analysis system coupled to the sensor that activates in response to a detected flow, wherein the flow analysis system collects and analyzes sensor data from the sensor.

### BRIEF DESCRIPTION OF THE DRAWINGS

These and other features of this disclosure will be more readily understood from the following detailed description of the various aspects of the disclosure taken in conjunction with the accompanying drawings in which:

FIG. 1 shows a perspective view of a fluid flow sensor having a low frequency flow detector configuration according to embodiments.

FIG. 2 shows fluid flow sensor system configured for measuring flow in a toilet according to embodiments.

FIG. 3 shows a flow diagram of a low frequency flow detection process according to embodiments.

FIG. 4 shows a wave form for sensor sampling according to embodiments.

The drawings are not necessarily to scale. The drawings are merely schematic representations, not intended to portray specific parameters of the disclosure. The drawings are intended to depict only typical embodiments of the disclosure, and therefore should not be considered as limiting the scope of the disclosure. In the drawings, like numbering represents like elements.

### DETAILED DESCRIPTION

Aspects of this disclosure include a fluid flow sensor system that detects flow using low frequency sampling. Once flow is detected, the sensor can capture and analyze flow data to e.g., detect leaks, provide alerts, measure water flow, provide analytics for water use in a plumbing fixture, etc.

Suitable water management systems require accurate flow measurement to determine typical usage and detect abnormal conditions. At any plumbing fixture (e.g., a sink, toilet, tub, sprinkler, etc.) water does not flow most of the time. In operation, water flow will start at an arbitrary moment in time, continue with possibly variation in rate for some arbitrary duration, and then flow will cease. This behavior is referred to herein as a flow event. It is essential that a flow analysis system operates throughout the flow event to provide accurate flow data. To effectively achieve this, the system must be able to detect when a flow event occurs and when flow ceases. In many cases, the analysis system only needs to be powered during a flow event to conserve energy.

In typical prior devices, flow detection is implemented with dedicated flow detector sensors, e.g., conductive probes or vibration sensors. In such implementations, a processor has to use significant power to periodically check the status of the detector sensor for a flow event before returning to sleep. The use of such sensors also increases overall system complexity, introduces new failure modes, may require complex tuning to setup, and introduces periodic aging maintenance.

Embodiments provided herein include a system and method in which the same device is used for both flow detection and analysis, thereby reducing cost and improving reliability. In some aspects, the device can utilize direct measurement, such as with an inline flow meter or other measurement technique, or an indirect measurement, such as acoustic, electrical impedance, vibration, light, magnetic, radio frequency field signals, etc. Once flow is detected, the device can activate device or system activities, such as alerting a user, storing, removing, retrieving or sending data, turning other devices on or off, recording data, etc. Furthermore, in certain aspects, a low frequency sampling methodology is utilized to detect flow in a very low power mode that periodically turns power on and off, which is particularly useful where continuous monitor requires a prohibitive amount of energy, creates interference or noise, allows the signal to be less detectable, etc.

In illustrative embodiments, direct measurement occurs through an inline flowmeter, which operates as follows to measure and analyze flow. Fluids passing through the flowmeter impinge on the blades of a turbine causing it to rotate on an axis. One way to detect that the axis is rotating—and hence detect fluid flow—is to attach a permanent magnet to the axis. This will cause the magnet to rotate when the shaft rotates, resulting in a magnetic field that varies in position. The field variation is proportional to the speed and pressure of the flow through the turbine. A magnetic field sensor, such as a Hall effect sensor, can sense the change in the field strength, intensity, orientation, etc., at a stationary point around the flowmeter and convert this variation into an electrical signal that is easily processed by low-power electronic circuits. The magnetic field of the permanent magnet can be oriented relative to the axis in such a way to optimize detection by the field sensor. This sensing can take place in any position, e.g., above or below the plane of rotation, or along the outer circumference of the rotating turbine.

In some applications, the system can be continuously powered up to detect the changing field, and hence detect and measure flow. However, in situations where for example power is limited (e.g., a battery powered system), continuously powering the system is not practical. To address this, embodiments provided herein utilize a low frequency approach in which the sensor is periodically turned on and off. In one example, the sensor is powered up for only a small percentage of an overall elapsed time (e.g., less than 1%) to sample the magnetic field. For example, the sensor is turned on for less than a tenth of a second, four or five times per second. Note that particular variables such as the sample rate, power on-off frequency, dwell time, etc., can be configured for variety of factors such as a specific environmental condition, stability of the fluid, phase or multiphase conditions, or kinematic fluid state.

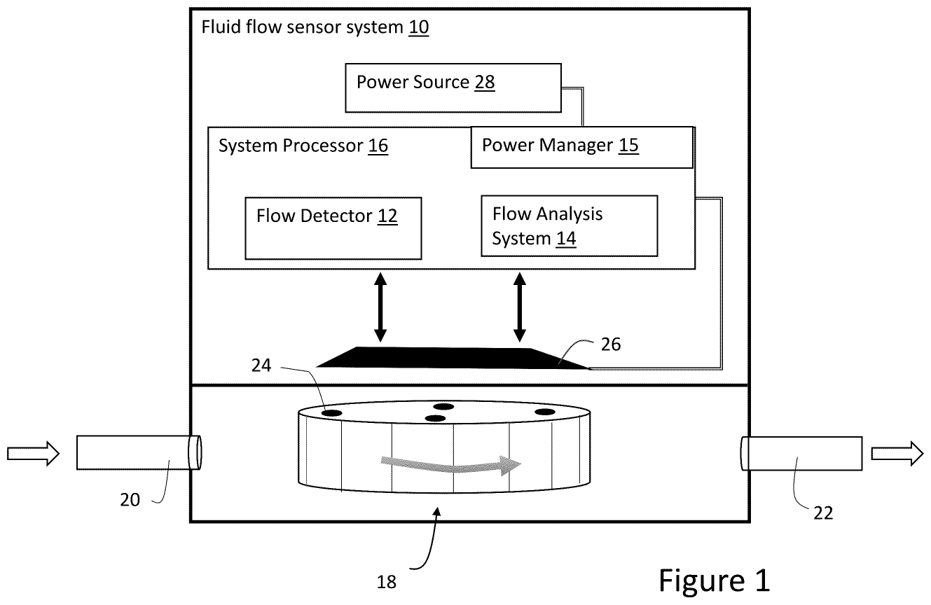

FIG. 1 depicts an illustrative fluid flow sensor system 10 which generally includes an intake port 20 for receiving a fluid, a turbine 18 that spins in response to a fluid flow event, and an outflow port 22 for discharging the fluid flow. In this embodiment, turbine 18 comprises a magnetic (Hall effect) sensor 26 that includes magnets 24 that rotate and generate a magnetic field when an event occurs. Turbine 18 may comprise any device having any shape or configuration capable of spinning or rotating in response to a fluid flow. Magnetic sensor 26 captures the magnetic field and converts the magnetic field into signals that are processed as digital or analog values by system processor 16.

In the illustrative system 10 of FIG. 1, water flow is analyzed in response to the rotating turbine 18 having magnets 24 that spins at a rate proportional to the water flow rate. The rotating magnets 24 create local magnetic field fluctuations (i.e., positional information) that can be detected with sensor 26. When not moving, sensor 26 can detect a position of the magnet(s)/turbine (e.g., between 0-360 degrees). When moving, the sensor 26 can for example generate pulses that can be counted by the flow analysis system 14 (i.e., flow analysis logic) in system processor 16. For example, the total counts for any particular flow event is proportional to the volume of water used during the event.

In addition to flow analysis system 14, system processor 16 also includes a flow detector 12 (i.e., detector logic) for detecting flow. As described herein, both flow detector 12 and flow analysis system 14 are configured to receive and sample data from sensor 26. Flow analysis system 14 however only powers up via power source 28 when a flow event is detected. Power source 28 provides power to the various components, and power manager 15 controls when flow detector 12, flow analysis system 14 and sensor 26 are powered up or powered down, which may include varying power states (e.g., activated, low power mode, sleep mode, etc.).

As noted, one of the challenges with measuring flow is that energy must be spent from a power source, either measuring flow events or waiting for a flow event to occur. In the period in between flow events, some amount of energy must be expended to detect flow. For devices that utilize a battery or the like for a power source, the expended energy over time can deplete the battery and thus increase cost. In applications where there are long durations between relatively short flow events, the time waiting to measure non-zero flows over sensor lifetime can be significantly greater than accumulated measurement durations.

Rather than utilizing additional probes to detect a new event, the present approach utilizes flow detector 12 that deploys a low frequency power management process to periodically power up and detect and evaluate a position of the turbine 18 based on the magnetic field using logic, e.g., implemented in software, hardware or firmware. Based on the positional information, flow detector 12 can detect a new flow event by comparing current and past positional values with minimal power consumption. Once detected, analysis system 14 gets “awakened,” but is otherwise maintained in power down state (e.g., a low-power or sleep mode).

Detecting flow is generally accomplished as follows. When the shaft rotation speed of turbine 18 is zero, there is no flow. In this state, the position of the turbine and hence the magnetic field is unchanging and periodic sampling by the sensor 26 will yield a sequence of unchanging values. When flow occurs, the position of the turbine 18 will change which will cause a non-periodic fluctuation of the magnetic field, and samples from the sensor will typically progress from values with no change to changing values. If the field is sampled at a fixed time period, the probability of seeing back-to-back identical values when flow is occurring is very low.

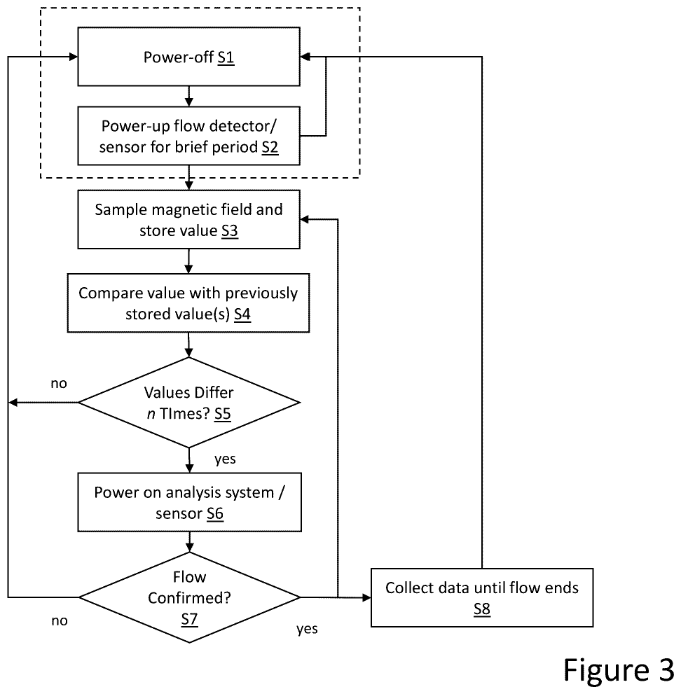

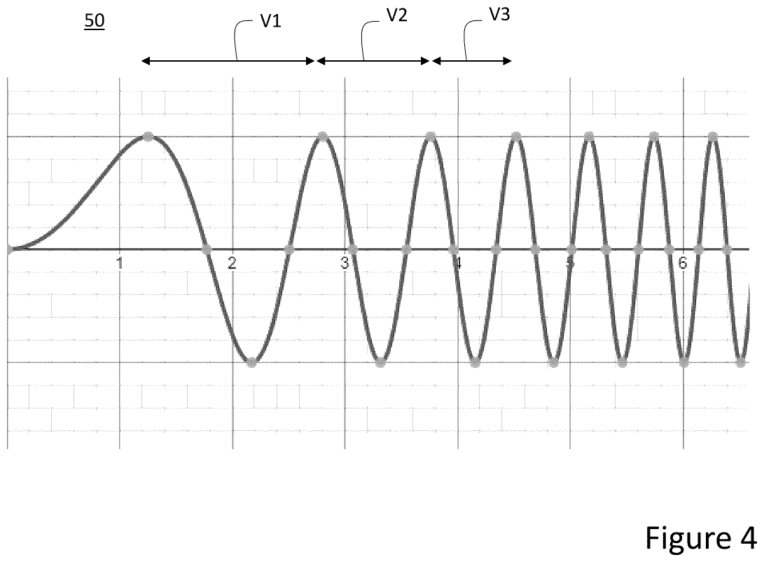

FIG. 3 depicts an illustrative process for detecting flow. At S1 and S2, flow detector 12 and sensor 26 are periodically powered up and down, e.g., during power down periods, sensor 26 is completely turned off and flow detector 12 is placed in a sleep mode. Both may for example be powered up four or five times per second for a few nanoseconds or milliseconds. At S3, during the brief period when the sensor 16 is powered, flow detector 12 samples and stores the state of the magnetic field as a quantifiable value, which essentially reflects a position of the turbine. For example, FIG. 4 depicts an illustrative field 50 generated by magnets on turbine 18, e.g., values V1, V2, V3 reflect different turbine angular velocities.

At S4 in FIG. 3, the value is compared with one or more previously stored values and at S5 a determination is made whether the values differ (which includes some tolerance threshold, e.g., +/−5%). If no difference is detected, i.e., the samples are identical, this indicates that no flow is occurring, the process returns to S1, and the flow analysis system 14 is not enabled, i.e., the analysis system 14 will remain in a sleep mode. However, if yes and the values differ, i.e., there is difference beyond a threshold between consecutive samplings (e.g., three times in a row), then the sensor 26 and the analysis system 14 are powered up at S6. The greater the number of samples that are compared, the greater the accuracy; however, comparing against one or two prior samples may be adequate. Once powered, the analysis system 14 determines at S7 if there is a flow present, e.g., flow is confirmed if there are detected repeating measured rotations of the turbine based on sensor readings. If the flow is not confirmed within a short time, e.g., two or three seconds, the process returns to S1 and the analysis system 14 and sensor 26 are immediately turned off and no data is recorded. If flow is detected (yes at S7), data is collected by the analysis system 14 at S8 until flow is no longer detected by analysis system 14. Analysis system 14 and sensor 26 are accordingly powered down once flow is no longer detected.

In certain embodiments, the system processor 16 instructs flow detector 12 to wake up, temporarily power on sensor 26 and take samples every 250 milliseconds while flow is not detected. Flow detector 12 collects and stores the previous sample and compares it to the current sample. Additionally, flow detector 12 also stores the number of times in a row the last sample was different than the current sample. The current sample after the comparison becomes the last sample for the next sampling. If two consecutive sample comparisons differ, then flow detector 12 “detects flow” and powers on the flow analysis system 14 and sensor 26. Using two consecutive samples instead of one help reduce the number of false positives and reduces the logic on the device implementing system processor 16.

The system processor 10 and associated components may be implemented with any type of computing system, e.g., one or more integrated circuits, chips, memory, bus, I/O, software, firmware, ASIC, etc., that includes logic for performing the tasks described herein. In certain embodiments, system processor 16 (including flow detector 12 and flow analysis system 14) can be implemented by a low-power processor (PIC), which can be directly powered by the battery. The low-power PIC can for example include an internal scheduler that periodically wakes itself up from a sleep mode to implement flow detector logic. The low-power PIC can also power sensor 26 and power up to implement flow analysis logic as needed. Flow detection and sensor voltage may for example vary from approximately 4.2V to 3.2V and utilize, e.g., 5 mA with power on (for the Honeywell SS411P) and 5 uA with the sensor off and the PIC in sleep mode.

When powering up sensor 26, its output becomes valid after a slight startup delay, which can be as low as 500 ns. For detection purposes, the pulse rate is irrelevant, it is not necessary to measure pulse rate since only presence of flow is of interest. As noted, a perceptible change of magnetic field values denotes flow. Accordingly, in the flow detection mode, sensor 26 can be powered up and read periodically to detect flow and conserve significant power, which is generally described with the formula:

I_{average}=DutyCycle*Iₒₙₜᵢₘₑ+I_{PICSleep}
Where:
I_{average}=Average current draw of the system in flow detect mode
Iₒₙₜᵢₘₑ=Hall sensor current when powered on
DutyCycle=% on-time of the sensor (e.g., 0.06%)
I_{PICSleep}=current draw of low-power processor in sleep mode
   As is evident, the shorter the DutyCycle, the greater the power savings. Accordingly, anything less than 100% will save power, and getting down below 1% will greatly reduce power.

The rotational rate of the turbine rapidly accelerates to match flow rate (which itself takes time to reach maximum rate) in less than a few seconds. Therefore, the magnetic field inflection rate increases gradually from some stable, steady value such as 0 up to some stable, steady positive value when flow starts. When the rotational rate is less than half the sampling rate (the Nyquist rate), the samples accurately reflect the magnetic field. There are some limitations that can be addressed by changing the size of the flowmeter. For example, at higher rotational rates, it is likely that “under-sampling” occurs. When under-sampling, the samples do not accurately reflect the magnetic field. At this point, the samples reflect the “beats” of the sampling rate verses the rotational rate due to what is known as aliasing. The frequency of the beats is less than that of the rotational rate and thus will provide an erroneous value that is lower than actual rates. When flow starts, there is a period of time before under-sampling occurs. If that period of time is more than that necessary to take two samples, then the two samples are guaranteed to be different, and flow has been detected. If flow still has not been detected and under-sampling is occurring, it is just a matter of time before subsequent samples are different. The only time subsequent samples will never change is when the rotational rate is within a certain tolerance of even multiples of the sampling rate (2×, 4×, 6×, etc.). Given that the rotational rate of the turbine cannot change instantaneously, subsequent samples will inevitably be different at some point. In an illustrative implementation, the sampling rate can be set at, e.g., four samples per second, or every 250 ms. The sensor 26 can be read 150 us after being powered-on to satisfy the startup delays with sufficient margin. In this example, sensor 26 is powered 0.06% of the time (150 us/250 ms), well less than one percent of an overall time period. A flow event is triggered any time a sample is different than, e.g., one or two previous samples.

In one embodiment, a sensor system 10 is provided that fits into or is integrated into the tank of a toilet, measures water flow or consumption, and communicates wirelessly with a remote data processing system that identifies leaks, reports demand data, issues alert conditions, calculates pressure, etc. In other embodiments, the sensor can reside external to the appliance.

Examples of such systems are for example described in U.S. Pat. No. 10,794,748, FLUID FLOW SENSOR SYSTEM FOR DETECTING FLOW EVENTS IN A TOILET, U.S. Pat. No. 11,015,968, FLUID FLOW SYSTEM HAVING A UNIVERSAL STEM, and U.S. Pat. No. 11,391,615, the contents of which are hereby incorporated by reference.

Almost all conventional toilets utilize water that is stored in a tank and released when flushed. After each flush, a re-fill event occurs within the toilet that includes a flow of water through a flexible fill tube and into an overflow tube. If there is a leak or other performance issue with the toilet (e.g., a malfunctioning flapper), more water will flow through the fill tube than is necessary during an event. In one embodiment, the sensor system only activates when water is flowing through the fill tube, thus minimizing power usage of the system. Raw data corresponding to an amount of flow is captured by the system and wirelessly transmitted to a remote data processing system for analysis.

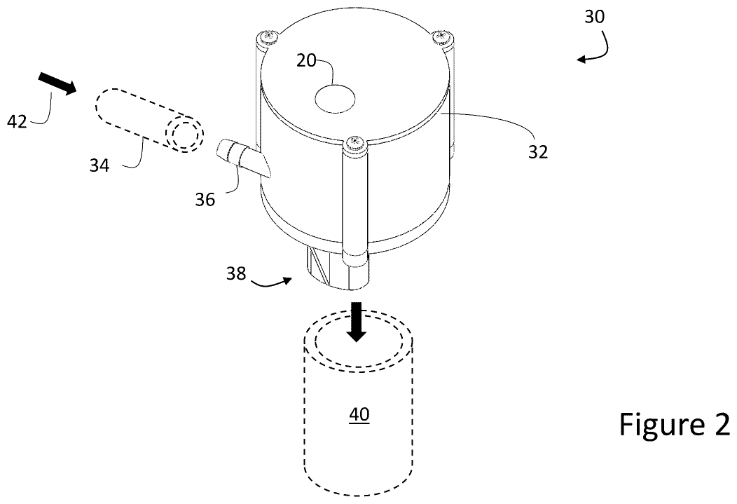

An illustrative toilet sensor system 30 is shown in FIG. 2. Sensor system 30 includes an enclosure 30 that includes, e.g., a turbine, Hall effect sensor, a power management system, a communication system, a data processing system (e.g., a battery, a WiFi transceiver, computer processor, etc.), etc. System 30 further includes an intake port 36 configured to connect to a fill tube 34 for receiving a flow of water 42, a turbine (not shown) which rotates in response to water flow 42, and an outflow port 38 including a mounting element that steers the waterflow downward to overflow tube 40. Although not shown in detail, water 42 flows through the flexible fill tube 34 into intake port 36, through the turbine, exits out through output port via mounting element and exits into the overflow tube 40. The intake port 36 is sized and configured to accept a standard fill tube 34 (e.g., with ribs or a clamp). The outflow port can be sized to expel the water into overflow tube 40.

Referring again to FIG. 1, when a flow event is occurring, Hall effect sensor 26 detects the magnetic field generated by magnets 24 on the turbine 18 that rotates in response to a flow of water and emits pulses based on the speed of the turbine 18, i.e., the flow rate of the water. Namely, the greater the flow rate, the greater the frequency of pulses. Flow analysis system 14 may be configured to count a number of pulses during predefined time intervals during the water flow event. For example, flow analysis system 14 may capture a signal count value every two seconds. The result is a packet of event data consisting of a series of flow rate values for a given flow event, e.g., (t₁=20, t₂=22, t₃=19, t₄=20, t₅=21, t₆=18 . . . t₃₀=17). Each value may for example represent the number of times a turbine spun during a two second interval. These short 1-9 second intervals are frequent enough to run a statistical analysis for more detailed insights into potential problems with the water appliance or water supply.

In various aspects, the embodiments described herein may be utilized for low-power detection of water flow in a toilet, a low-power detection and measurement of water flow in a toilet, low-power detection of water flow in any plumbing fixture, low-power detection and measurement of water flow in any plumbing fixture, low-power detection of fluid flow, a scheme for using a fluid flow measurement device for flow detection via low-frequency sampling, a fluid flow-detection mechanism based on sampling values of a magnetic field modulated by a rotating fluid turbine, a fluid flow-detection mechanism based on sampling values of any potential or field modulated by a rotating fluid turbine, a scheme for combining continuous-use low-power and occasional-use high-power devices to reduce total power consumption of a fluid flow analysis system, or a scheme for combining continuous-use low-power and occasional-use high-power devices to reduce total power consumption of a combined system.

In some embodiments, flow analysis system 14 can analyze the data locally, e.g., compare two samples to determine a change in the state, a change in flow rate, etc. In some instances, e.g., an emergency, the system will communicate out an emergency message immediately. In other instances, the data is transmitted at predetermined periodic times to a local server and/or cloud platform or the like for subsequent analysis.

In certain cases, the event data can be wirelessly transmitted to a remote data processing service for analysis in a communication mode. Transmission may occur at the time of the event, or any time thereafter. Transmission may also be initiated by the user or external device. In one illustrative embodiment, a collection of event data records are transmitted in a batch mode at predefined time intervals, e.g., every eight hours.

In addition to event data, device data such as continuous device health monitoring can be reported in data transmissions. Other device data may, e.g., include battery voltage, temperature, relative humidity, atmospheric pressure, ambient optical brightness, sound noise level, VOC gas sensor readings, electric current, liquid or gaseous hydrogen-based fuels, etc. Communication related data may also be included, e.g., data collected from channel monitoring such as signal strength, background noise level, metrics for interference problems, retry counter, association failure rate, packet demodulation failure rate, etc.

It is noted that the systems described herein can be configured for analyzing any type of configuration of fluid flow, and can be adapted in any configuration or manner along any fluid flow path, e.g., fill tube, overflow tube, pipe, channel, hose, drain, faucet, etc. Furthermore, the sensor system can be utilized with different types of fluid, e.g., liquid, gas, mixtures, natural gas, propane, heating oil, etc.

Additionally, while described herein to include a turbine and magnets to generate a magnetic field in response to a fluid flow, it is understood that other types of devices and signals could be used. For example, any type of actuator that moves in response to a fluid flow and is capable of outputting positional information could be utilized, e.g., a pendulum, a flap, a screw, a material, a membrane.

Computing and processing systems utilized herein may comprise any type of computing device, integrated circuit, analog device, and for example includes at least one processor, memory, an input/output (I/O) (e.g., one or more I/O interfaces and/or devices), and a communications pathway. In general, processor(s) execute program code which is at least partially fixed in memory. While executing program code, processor(s) can process data, which can result in reading and/or writing transformed data from/to memory and/or I/O for further processing. The pathway provides a communications link between each of the components in computing system. I/O can comprise one or more human I/O devices, which enable a user to interact with computing system. Computing system may also be implemented in a distributed manner such that different components reside in different physical locations.

The foregoing description of various aspects of the disclosure has been presented for purposes of illustration and description. It is not intended to be exhaustive or to limit the disclosure to the precise form disclosed, and obviously, many modifications and variations are possible. Such modifications and variations that may be apparent to an individual in the art are included within the scope of the disclosure as defined by the accompanying claims.

1. A system for detecting and analyzing fluid flow, comprising:
a turbine that rotates in response to a fluid flow;
a sensor that senses positional information of the turbine;
a flow detector coupled to the sensor that periodically:
captures and stores a value indicative of a position of the turbine;
compares the value with a previously collected value; and
detects flow if the value and previously collected value differ; and
a flow analysis system coupled to the sensor that activates in response to a detected flow, wherein the flow analysis system collects and analyzes data from the sensor until flow ends.

2. The system of claim 1, further comprising a power manager that, during a flow detect mode, maintains the flow detector and sensor in a power down mode and periodically powers up the flow detector and sensor to capture and store the value, perform the compare, and detect flow.

3. The system of claim 2, wherein the flow detector and sensor are powered up less than one percent of an overall time.

4. The system of claim 1, wherein the flow analysis system confirms the detected flow prior to collecting and analyzing sensor data.

5. The system of claim 2, wherein the flow analysis system is powered down by the power manager when not activated and when activated powers up the flow analysis system and sensor to operate in an analysis mode.

6. The system of claim 1, wherein the sensor comprises a magnetic field sensor.

7. The system of claim 1, wherein the system for detecting and analyzing fluid flow is integrated into a plumbing fixture.

8. A method for detecting and analyzing fluid flow, comprising:
providing a turbine that rotates in response to a fluid flow;
providing a sensor that senses positional information of the turbine;
periodically capturing and storing a value indicative of a position of the turbine;
comparing the value with a previously collected value;
detecting a fluid flow if the value and previously collected value differ; and
activating a flow analysis system in response to a detected flow, wherein the flow analysis system collects and analyzes data from the sensor.

9. The method of claim 8, further comprising periodically powering the sensor on and off.

10. The method of claim 9, wherein the sensor is powered on less than one percent of an overall time.

11. The method of claim 8, wherein the flow analysis system confirms the detected flow prior to collecting and analyzing sensor data.

12. The method of claim 9, wherein logic for capturing, storing, comparing and detecting is periodically powered off by a power manager.

13. The method of claim 1, wherein the sensor comprises a magnetic field sensor.

14. The method of claim 1, wherein the method for detecting and analyzing fluid flow is integrated into a plumbing fixture.

15. A plumbing fixture, comprising:
system for detecting and analyzing fluid flow, including:
a turbine that rotates in response to a fluid flow;
a sensor that senses positional information of the turbine;
a flow detector coupled to the sensor that periodically:
captures and stores a value indicative of a position of the turbine;
compares the value with a previously collected value; and
detects flow if the value and previously collected value differ; and
a flow analysis system coupled to the sensor that activates in response to a detected flow, wherein the flow analysis system collects and analyzes data from the sensor.

16. The plumbing fixture of claim 15, wherein fixture comprises a toilet and the flow analysis system measures water flow in the toilet.

17. The plumbing fixture of claim 15, further comprising a power manager that maintains the flow detector and sensor in a power down mode and periodically powers up the flow detector and sensor to capture the value.

18. The plumbing fixture of claim 17, wherein the flow detector and sensor are powered up less than one percent of an overall time.

19. The plumbing fixture of claim 15, wherein the flow analysis system confirms the detected flow prior to collecting and analyzing sensor data.

20. The plumbing fixture of claim 15, wherein the sensor comprises a magnetic field sensor.
